(19) United States
(12) Patent Application Publication
(10) Pub. No.: US 2004/0231947 A1
(43) Pub. Date: Nov. 25, 2004

(54) Method for determining a displacement state of a clutch actuator in a vehicle

(75) Inventor: Markus Baehr, Achern (DE)

Correspondence Address: Robert P. Simpson, Esq., Simpson & Simpson, PLLC, 5555 Main Street, Williamsville, NY, 14221-5406, US

(73) Assignee: LuK Lamellen und Kupplungsbau Beteiligungs KG, Buhl (DE)

(21) Appl. No.: 10/762,929

(22) Filed: Jan. 22, 2004

(30) Foreign Application Priority Data
Jul. 23, 2001 (DE) 101 35 851.2
Jul. 18, 2002 (WO) PCT/DE02/02647

(51) Int. Cl. B60K 41/00

(52) U.S. Cl. 192/84.6

(57) ABSTRACT

A method for determining the displacement state of a clutch actuator is proposed for a vehicle, the clutch actuator being driven by an electric motor. According to the invention, the armature resistance (R_{A}) of the electric motor is determined in a stationary state of the electric motor, a current induced in the electric motor (I_{Ind}) and/or an induced voltage (U_{Ind}) being calculated with the determined armature resistance (R_{A}) and the applied motor voltage (U) as well as the measured motor current (I), and the displacement state of clutch actuator being determined form the induced current (I_{Ind}) and/or the induced voltage (U_{Ind}), which are proportional to the motor speed (n).

### CROSS-REFERENCE TO RELATED APPLICATION

This patent claims the benefit under 35 U.S.C. § 120 and § 365 (c) of International Patent Application PCT/DE02/02647, filed Jul. 18, 2002 and published Feb. 27, 2003, and incorporated herein by reference. This patent also claims priority of German Patent Application No. 101 35 851.2, filed Jul. 23, 2001, which application is incorporated herein by reference.

### BACKGROUND OF THE INVENTION

The invention relates to a method for determining a displacement state of a clutch actuator in a vehicle, the clutch actuator being driven by an electric motor.

Methods for determining the displacement state of a clutch actuator are known in the art. For example, stoppage against an abutment can be detected as a displacement state of the clutch actuator. Based on measurement precisions for the known method, it is necessary to perform a check of the specified displacement states at regular intervals so that a recalibration is possible.

### OBJECT OF THE INVENTION

Consequently, the object of the present invention is to specify a method for determining a displacement state that enables the aforementioned procedure. Furthermore, the objective is to implement, simply and reliably, a position re-initialization for the actuator by measurement of the armature resistance.

### BRIEF SUMMARY OF THE INVENTION

Accordingly, a method according to the invention is proposed in which armature resistance R_{A} of the electric motor is determined, wherein a current I_{Ind} induced in the electric motor and/or an induced voltage U_{Ind} can be calculated using determined armature resistance R_{A} and applied motor voltage U as well as measured motor current I, and wherein from the induced current I_{Ind} and induced voltage U_{Ind}, which are proportional to the motor speed n, the displacement state of the clutch actuator is determined. In this way, a position of the clutch actuator can be detected.

### DETAILED DESCRIPTION OF THE PREFERRED EMBODIMENT

From the following equation, it is evident that preferably motor current I as a function of speed n can be used to determine a movement state. In particular, a current I_{Ind} induced by the motor speed is used in this connection as a signal:

n∝I_{Ind}=U_{IND}/R_{A}=U/R_{A}−1

wherein

n=motor speed;

I_{Ind}=induced current;

U_{Ind}=induced voltage;

R_{A}=armature resistance;

I=motor current on the electric motor;

U=motor voltage on the electric motor.

The voltage U_{Ind} induced in the electric motor is likewise proportional to the motor speed n and can be calculated by the following equation:

U_{Ind}=kₑ·n

wherein

n=motor speed;

U_{Ind}=induced voltage;

kₑ=proportionality factor.

However, in the determination of a displacement state, it is necessary to determine armature resistance R_{A} as precisely as possible. Armature resistance R_{A} is a function in particular of the temperature of the armature windings. Moreover, aging effects can still occur in this case due to the wear and tear on the brushes, e.g., carbon brushes on the commutator. It is therefore expedient to measure armature resistance R_{A} at regular intervals.

The measurement of the armature resistance occurs at a stationary state of the clutch actuator, preferably when the electric motor is idle. In order to determine when the electric motor is really idle, it is advantageous to use a clutch actuator having a self-locking transmission. In a self-locking transmission, there is a braking torque that acts against any motor torque. If the torque caused by motor voltage U (U∝I∝M) is smaller than the braking torque of the transmission plus the friction in the motor, the motor remains stopped despite applied voltage U. In this motor current I is set

I=U/R_{A}

Thus, armature resistance R_{A} may be determined by a current measurement at known voltage U. Possible imprecision in the measurement of a small current I may be reduced in this case by a timed averaging, e.g., by a hardware low-pass or numerically in the control device. Because the motor is in a stationary state, the armature inductivity is not taken into consideration in the measurement. The measurement of the armature resistance R_{A} can occur here in any desired position of the clutch actuator. Furthermore, the thermal stress of the motor is kept low in an advantageous manner.

The method of the invention may preferably be used for a clutch actuator with incremental path measurement. Here, a recalibration of the clutch actuator may be carried out at regular intervals or shortly before armature resistance R_{A} is needed, namely for position reinitialization. Based on the functional connections

n∝I_{Ind}=U/R_{A}−1 and

I=U−U_{IND}/R_{A}=U/R_{A}−U_{IND}/R_{A}=U/R_{A}−I_{IND}

the displacement state of the clutch actuator can be determined with respect to motor current I at a known armature resistance R_{A}. In this context this signal is independent from applied motor voltage U. Only given strong current changes I can the signal be affected by the armature inductivity. In this manner, a standstill of the motor or the clutch actuator, for example, can be determined by the method of the present invention. The determination of the exact position may preferably occur at an abutment or a detent. It is also possible that changes in the speed of the electric motor are measured. Therefore, detents or also, for example, “soft” stops can be detected.

From the above equations, induced current I_{Ind}, which is proportional to the motor speed, can thus be calculated.

The use of induced current I_{Ind} as a signal even enables development of an emergency operation strategy, for example, when there is a failure of the incremental position encoder. Because the measurement of armature resistance R_{A} is needed to compensate for changes in armature resistance R_{A}, the causes for these changes may also be determined indirectly by the method of the invention.

By measuring R_{A}, the motor temperature may also be deduced. At minimum, voltage U at known armature resistance R_{A} may be selected such that the desired current and thus the desired torque on the motor is produced. This is of interest, for example, for timing motors. However, in this case the method for measurement of the armature resistance should be adjusted because a self-locking transmission is not being used.

Especially for carrying out the method of the present invention, a device for measuring the armature resistance for small voltages may be used for the recalibration of the rotary speed measurement with the motor current on the clutch actuator.

The patent claims submitted along with the application are formulation proposals without prejudice for the attainment of ongoing patent protection. The applicant reserves the right to claim additional feature combinations that so far are only disclosed in the description and/or drawings.

References used in the dependent claims point to the further formation of the subject matter of the main claim by the features of each dependent claim; they are not to be understood as renunciation of the attainment of a separate, concrete protection for the feature combinations of the referred dependent claims.

Because the subject matter of the dependent claims can form separate and independent inventions with respect to the state of the art on the priority date, the applicant reserves the right to make them the subject matter of independent claims or separation statements. They can furthermore also include independent inventions that have a configuration independent of the subject matters of prior dependent claims.

The exemplary embodiments are not to be understood as a limitation of the invention. Rather, numerous amendments and modifications are possible within the context of the present publication, especially such variants, elements and combinations and/or materials that can be inferred by one skilled in the art with regard to the resolution of the problem using, for example, a combination or modification of individual features or elements or methodological steps that are described in connection with the general description and embodiments as well as the claims and are contained in the drawings and, using combinable features, lead to a new subject matter or to new methodological steps or methodological sequences, even if they pertain to manufacturing, testing and operating method.

What is claimed is:

1. A method for determining a displacement state of a clutch actuator for a vehicle, the clutch actuator being driven by an electric motor, wherein the armature resistance (R_{A}) of the electric motor is determined in a stationary state of the electric motor, at the determined armature resistance (R_{A}) and applied motor voltage (U) as well as measured motor current (I), a current (I_{Ind}) induced in the electric motor and/or an induced voltage (U_{Ind}) are calculated, and from the induced current (I_{Ind}) and/or induced voltage (U_{Ind}), which are proportional to the motor speed (n), the displacement state of the clutch actuator is determined.

2. The method as described in claim 1, wherein the armature resistance (R_{A}) is determined by the following equation:
I=U/R_{A}
wherein
I=measured motor current;
U=applied motor voltage;
R_{A}=armature resistance.

3. The method as described in claim 1, wherein the motor speed (n), which is a function of the induced current (I_{Ind}) is determined by following equation:
n∝I_{Ind}=U_{IND}/R_{A}=U/R_{A}−I
wherein
n=motor speed:
I_{Ind}=induced current;
U_{Ind}=induced voltage;
R_{A}=armature resistance;
I=motor current on the electric motor;
U=motor voltage on the electric motor.

4. The method as described in claim 3, wherein the induced voltage (U_{Ind}) is calculated as a function of the motor speed (n) by the following equation:
U_{Ind}=kₑ·n
wherein
n=motor speed;
U_{Ind}=induced voltage;
kₑ=proportionality factor.

5. The method as described in claim 4, wherein for a clutch actuator having incremental travel measurement, a recalibration is carried out by determining the armature resistance (R_{A}) at pre-determined time intervals.

6. The method as described in claim 5, wherein when there is a failure of the incremental position encoder, the induced current (I_{Ind}) is used to carry out an emergency operation strategy.

7. The method as described in claim 1, wherein a change of the motor speed n of the electric motor is detected with the respect to the motor current (I) in order to determine the position of the clutch actuator at an abutment and/or a detent.

8. The method as described in claim 1, wherein the motor temperature is determined at a known armature resistance (R_{A}).

9. The method as described in claim 1, wherein the motor voltage (U) is selected at a determined armature resistance (R_{A}) in such a manner that a specific motor current (I) and a specific torque is produced at the motor.
